(19) United States
(12) Patent Application Publication
(10) Pub. No.: US 2007/0181822 A1
(43) Pub. Date: Aug. 9, 2007

(54) Method and apparatus for fluorescent magnetic particle and fluorescent liquid penetrant testing

(76) Inventors: Charles Harris Mazel, Bedford, MA (US); Lawrence Goldberg, Merritt Island, FL (US)

Correspondence Address: CLOCK TOWER LAW GROUP, 2 CLOCK TOWER PLACE, SUITE 255, MAYNARD, MA, 01754-2545, US

(21) Appl. No.: 11/702,235

(22) Filed: Feb. 5, 2007

Related U.S. Application Data
(60) Provisional application No. 60/765,633, filed on Feb. 6, 2006.

(51) Int. Cl. G01N 23/12

(52) U.S. Cl. 250/432 R

(57) ABSTRACT

The invention includes a method and apparatus for viewing fluorescent indicating materials for performing fluorescent magnetic particle testing and fluorescent liquid penetrant testing. In this method of nondestructive testing, the invention replaces ultraviolet light with the combination of a source of blue light that is substantially or entirely devoid of ultraviolet radiation and a yellow barrier filter. The method uses fluorescent indicating materials currently commercially available and originally designed for use with ultraviolet light sources.

### CROSS-REFERENCE TO RELATED APPLICATIONS

This utility patent application claims priority from U.S. provisional patent application Ser. No. 60/765,633, filed Feb. 6, 2006, entitled “Method and apparatus for fluorescent magnetic particle and fluorescent liquid penetrant testing” in the name of Charles Mazel.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2007 BlueLine NDT.

### BACKGROUND OF THE INVENTION

1. Field of the Invention

This invention relates to nondestructive testing, examination, and evaluation. More specifically, this invention relates to fluorescent magnetic particle testing and fluorescent liquid penetrant testing.

2. Description of Prior Art

Magnetic particle and liquid penetrant methods are used in many industries to test materials for cracks or other defects. Both of these methods, which fall within the general category of nondestructive testing, aim to create visual indications of defects that a person performing a test can see with the naked eye or that can be recorded with a still or video camera. Visual indications are created by introducing into a defect an indicating material that produces enhanced visual contrast. Both methods can be implemented either with indicating materials that are designed to be viewed with bright white-light illumination or with fluorescent indicating materials that are designed to be stimulated to fluoresce and to be viewed under low ambient illumination while being stimulated. In the field of magnetic particle testing there exist dual use indicating particles that are designed to be used with either type of light source.

Magnetic particle testing can be used with materials that can be magnetized (ferritic materials), such as steel. Magnetic particle testing uses a variety of means for inducing a magnetic field in the material. As one example of a common technique, an electromagnetic yoke has two movable legs capable of being positioned on a test subject, with one leg on each side of an area to be tested. When the yoke is energized the yoke creates a magnetic field that extends from the tip of one leg to the tip of the other, passing through the test subject. A surface-breaking or near-surface defect in the test subject results in localized flux leakage from the surface. An indicating medium comprising colored magnetic particles is then introduced at the surface of the magnetized area. Magnetic particles can either be applied in dry form or in a liquid carrier. A gentle flow of air or water (depending on whether the test is being conducted in air or underwater) is then applied over the surface. Magnetic particles at defects are held in place by flux leakage, while particles on other portions of the surface are removed by the flowing air or water, or, in the case of vertical or overhead surfaces, by gravity. The surface is then viewed under illumination with an appropriate light source to see if there is an indication of a possible defect.

Liquid penetrant testing uses a similar approach but is applicable to both ferritic and non-magnetic materials. Liquid penetrant testing comprises a liquid that contains an indicating dye and is applied to a test surface. Time is allowed for the liquid penetrant to enter cracks or pits, and then the surface is wiped off. A second coating called a developer is then added. The developer draws the indicating dye to the top of a crack, at the same time broadening the indication and thus making it easier to see. The indicating materials are then viewed under illumination with an appropriate light source.

In both magnetic particle and liquid penetrant testing there are indicating particles and dyes designed to be viewed under white light illumination and particles and dyes designed to fluoresce and be viewed under ultraviolet illumination in darkened conditions.

Methods for magnetic particle and liquid penetrant testing are prescribed by various standards documents drafted by ASTM International (originally known as the American Society for Testing and Materials), 100 Barr Harbor Drive, West Conshohocken, Pa., 19428 or by a number of other groups, including American Petroleum Institute, American Bureau of Shipping, and others. Relevant documents include ASTM E-1444 “Standard Practice for Magnetic Particle Examination” and ASTM E-1417 “Standard Practice for Liquid Penetrant Examination.” Both of these publications, and other related ASTM publications, specify the use of ultraviolet light (also called black light) for viewing of fluorescent indicators. More specifically, the ultraviolet light is in what is called the UV-A range, from 320 to 400 nanometers (3200 to 4000 Angstroms). The specifications further state that the peak emission of the ultraviolet light source should be at 365 nanometers. ASTM E-1444 specifically states in section 6.2.2 that “UV-A sources used for NDT, employ appropriate filters, either internal or external to the light source to minimize the visible light output (400 nm (4000 Å) to 760 nm (7600 Å)) that is detrimental to the fluorescent inspection process.” A minimum intensity of 1,000 microwatts per square centimeter at the surface under inspection is specified.

There exists a requirement, as codified in standards (ASTM and others) related to fluorescent inspections, that restricts the ambient light level in which it is permissible to conduct inspections to 2 footcandles. This restriction exists because ambient light reduces the contrast between fluorescing indications and non-fluorescent surroundings, thus decreasing detection sensitivity. Consequently, fluorescent inspections are typically carried out in darkened conditions. Manufacturing facilities usually have dedicated inspection areas in which the light level can be controlled. Creating a darkened environment can be problematic indoors in open production areas, and is even more so outdoors. In some cases portable tents are used to create local areas of darkness. One approach to working in the presence of ambient light is to provide higher intensity excitation illumination. This solution requires higher power lights, usually at higher expense, with bulkier power supplies and greater heat generation.

One method of viewing fluorescence in the presence of ambient light is disclosed in, for example, U.S. Pat. No. 4,336,459 (Fay, Jun. 22, 1982), entitled “Method and Apparatus for Detecting Fluorescence Under Ambient Light Conditions,” and U.S. Pat. No. 6,177,678 (Brass, Jan. 23, 2001), entitled “Method and Apparatus for Leak Detection and Non-Destructive Testing.” This method uses a pulsed rather than a steady light source, in which the pulse rate is below the flicker fusion frequency of the human eye so that pulsing is apparent to the observer. It is known that pulsing (flashing) lights are more evident to an observer than a steady light. A pulse rate in the neighborhood of 10 hertz works well. Both of these patents describe using ultraviolet light for exciting fluorescence.

There are five primary manufacturers of fluorescent indicating particles and dyes for magnetic particle and liquid penetrant testing: Circle Systems, 479 W. Lincoln Avenue, Hinckley, Ill. 60520, USA; Magnaflux (a division of Illinois Tool Works), 3624 W. Lake Avenue, Glenview, Ill. 60026, USA; Ely Chemical Company Limited, Lisle Lane, Ely, Cambridgeshire, CB7 4AS, United Kingdom and 2603 N. Foundation Drive, South Bend, Ind. 46628, USA; Chemetall Oakite, 50 Valley Road, Berkeley Heights, N.J. 07922, USA; and Sherwin Incorporated, 5530 Borwick Avenue, South Gate, Calif. 90280, USA. All of these manufacturers explicitly state in their literature that the materials are to be used with ultraviolet light. For example, the MAGNAGLO operating instructions provided by Magnaflux state that “with nonfluorescent particles, indications will be visible in normal light, but remember you'll need to view the part under a black light to see fluorescent particle indications.”

Several companies that sell fluorescent materials also supply ultraviolet lights. There are other companies, including Spectronics Corporation, 956 Brush Hollow Road, Westbury, N.Y. 11590 USA, UVP Inc., 2066 W. 11th Street, Upland, Calif. 91786 USA, and Labino AB, Industrivägen 8, 171 48 Solna, Sweden that supply ultraviolet lights to the nondestructive testing industry.

The required use of ultraviolet light has a number of disadvantages that are known to trained practitioners of fluorescent magnetic particle and fluorescent liquid penetrant testing.

While the UV-A range of wavelengths used for fluorescent magnetic particle and fluorescent liquid penetrant testing is not as dangerous as shorter-wavelength ultraviolet light, it is still not considered eye-safe and extended exposure is considered undesirable. ASTM publication E2287-04, “Standard Guide for Use of UV-A and Visible Light Sources and Meters used in the Liquid Penetrant and Magnetic Particle Methods,” states in section 8.2.1 that “It is recommended by most UV-A lamp manufacturers that users wear non-photochromatic eyewear (goggles or glasses) when performing inspections. The eyewear should be made of clear optical material (not tinted) and possess UV-blocking capabilities. It is also recommended by UV-A light manufacturers that users wear long-sleeve clothing, gloves and a hat to minimize direct exposure of radiation to the skin.”

While there are a few sources of intense ultraviolet radiation that are battery-operated, most of the available sources require power cords supplying power from electric mains and are relatively bulky. UV lights used in the nondestructive testing industry typically have two components: an electrical ballast, and the lamp itself attached to the ballast by a wound electrical cord, typically six feet. Typical UV light systems weigh upwards of eight pounds. If an inspection area is greater than six feet away from the current position of the ballast then the ballast must be moved. Moving such UV light systems is very difficult to do on long inspection areas. The size of the lights, in combination with the other equipment required for testing, means that two people are required to perform an inspection, with an inspector applying the fluorescent materials and viewing the indications while an assistant holds the UV light source. Inspection locations can at times be cramped, and in such locations it is difficult for two people to fit in a space and work together. Requiring a second person to position a light source adds significant cost to the overall cost of an inspection job.

Ultraviolet lights used for nondestructive testing generate substantial heat. This heat can make working conditions uncomfortable in tight quarters such as boilers. It is not uncommon for operators to sustain burns from contact with hot UV lights. Heat from UV lights can also be dangerous as an ignition source if there are flammable materials in the work area.

Most ultraviolet lights used for nondestructive testing require a minute or more of warm-up time before reaching full intensity to be suitable for use. Furthermore, most ultraviolet lights employ arc discharge type bulbs that, if turned off after being used for a period, require a cool-down time of a minute or more before the bulb can be re-lit. Due to long warm-up and cool-down times, ultraviolet lights are generally left on even when they are not directly in use.

Ultraviolet lights suitable for use in fluorescent magnetic particle testing or fluorescent liquid penetrant testing tend to be relatively expensive.

Thus, the use of ultraviolet light as specified by the standards committees and by particle and lighting manufacturers for fluorescent magnetic particle testing and fluorescent liquid penetrant testing has significant disadvantages. UV light is not inherently safe to eyes and skin; UV light systems are bulky, requiring a second operator; UV lights generate substantial waste heat; UV lights can be inconvenient to work with due to limited ability to turn them on and off and to use them as soon as they are turned on; and the lamps required to produce the necessary light are relatively expensive.

Fluorescence is defined as the absorption of electromagnetic radiation at one wavelength (frequency) and its subsequent re-emission at another wavelength. The definition does not specify ultraviolet light, and in fact may involve electromagnetic radiation of any wavelength, whether of light, x-rays, or other. The possibility of using wavelengths of light other than ultraviolet light to stimulate fluorescence of particular substances is described in U.S. Pat. No. 6,914,250 issued to Seville on Jul. 5, 2005 entitled “Fluorometric detection in visible light”, the contents of which are hereby incorporated by reference. The Seville patent applies primarily to the use of blue light to stimulate fluorescence in fluorophors used in biological research. The basic principles employed, including a light source with a first filter to select the visible wavelengths needed to stimulate fluorescence combined with a second filter to transmit the fluorescence to the eye or other detector while blocking the reflected excitation light, have long been known to skilled practitioners in diverse fields such as fluorescence microscopy and forensic investigation. The significance of the '250 patent is in teaching the applicability of the technique to the specific applications described in the patent, combined with design of specific apparatus for implementing the technique with appropriate means.

U.S. Pat. No. 3,774,030 (O'Connor, Nov. 20, 1973) entitled “Defect detecting and indicating means for non-destructive testing” discloses a defect detecting and indicating means for magnetic particle or penetrant systems in which defect indications are produced on the surface of a part. The O'Connor patent describes a technique for doing nondestructive testing using a laser. The laser emits blue light and fluorescence is imaged—by eye or by a detector—through a blocking filter. The laser beam is optionally scanned for automated pattern recognition. The technique for exciting the fluorescent dye is described in general terms, not specific to excitation wavelength. O'Connor teaches using an ultraviolet light source for good suppression of source light while observing small fluorescent indications.

U.S. Pat. No. 4,956,558 (Sep. 11, 1990, Batishko) entitled “System for measuring film thickness,” discloses a system for determining the thicknesses of thin films of materials exhibiting fluorescence in response to exposure to forms of excitation energy such as blue-green or ultraviolet light. The fluorescent light detection mechanism may constitute a photomultiplier tube used in combination with a long-wave pass optical filter adapted for passing fluorescent light while blocking any blue-green light which may be reflected back down a probe. Batishko focuses on measuring the thicknesses of oil films on machine components which are ordinarily obscured from view.

U.S. Pat. No. 6,975,391 (Dec. 13, 2005, Asano) entitled “Method and apparatus for non-destructive testing,” discloses a deficiency inspection method using a video technique for detecting fluorescent indications. Asano focuses on automatic or computer-assisted detection of indications. The excitation light source for fluorescence is ultraviolet light.

None of the above provides a method of nondestructive fluorescent testing that uses a light source not harmful to eyes and skin, that uses a light source that is lightweight and compact and capable of being managed by one operator, and that can be quickly powered on and off. What is needed, therefore, is a method of nondestructive testing that overcomes the above-mentioned limitations and that includes the features enumerated above. cl BRIEF SUMMARY OF THE INVENTION

The invention includes a method and apparatus for performing fluorescent magnetic particle testing and fluorescent liquid penetrant testing and viewing the resulting indications. In this method of nondestructive testing, the invention replaces ultraviolet light with the combination of a source of blue light that is substantially or entirely devoid of ultraviolet radiation and a yellow barrier filter. The method uses fluorescent indicating materials currently commercially available and designed for use with ultraviolet light sources.

Blue light is able to stimulate fluorescence from many indicating materials already available from the aforementioned manufacturers. When blue light is used to excite fluorescence, some blue light is absorbed by a fluorescing substance and some blue light is reflected from that substance and from surrounding non-fluorescent surfaces. If reflected blue light reaches the eye it will interfere with the eye's ability to see fluorescent indications. A yellow filter is used to prevent reflected blue light from reaching the eye to improve contrast. The properties of the source of blue light and the yellow barrier filter are selected so that the filter prevents substantially all of the reflected blue light from reaching the eye of an observer.

Blue light for exciting fluorescence in the present invention may be provided by a broad-spectrum white light source fitted with a filter that passes only the desired wavelengths, or by a narrower-band source such as a high intensity light-emitting diode (LED). The preferred light source is one or more LEDs capable of exciting fluorescence, such as, but not limited to, the Luxeon® Royal Blue 3W Star LEDs (product code LXHL-LR3C) supplied by Lumileds Lighting, LLC of San Jose, Calif. The output of an LED may be further improved by adding a light filter such as an interference-type excitation filter supplied by NightSea LLC of Andover, Mass.

The method and associated apparatus of this invention have several advantages, including that the invention is inherently eye and skin safe, is compact, generates relatively little heat, can be turned on and off at any time, requires no warm-up before it can be used, and is relatively inexpensive.

### BRIEF DESCRIPTION OF THE DRAWINGS

In the drawings, closely related figures and items have the same number but different alphabetic suffixes. Processes, states, statuses, and databases are named for their respective functions.

FIG. 1 is drawing of a source of blue light.

FIG. 2 is a drawing of filter glasses.

FIG. 3 is a graph showing the spectrum of the NightSea blue light excitation filter.

FIG. 4a-4b are graphs showing the impact of an excitation filter.

FIG. 5a-5b are drawings of a headlamp light source.

FIG. 6 is a graph showing a fluorescence excitation spectrum of dusting powder.

FIG. 7 is a graph showing a fluorescence excitation spectrum of dusting powder.

FIG. 8 is a graph showing a transmission spectrum for a yellow barrier.

### DETAILED DESCRIPTION OF THE INVENTION, INCLUDING THE PREFERRED EMBODIMENT

Terminology

The terminology and definitions of the prior art are not necessarily consistent with the terminology and definitions of the current invention. Where there is a conflict, the following definitions apply.

Ultraviolet light—includes electromagnetic radiation having a wavelength shorter than approximately 400 nanometers. Near ultraviolet light is 320-400 nanometers. Wavelengths of light above 400 nanometers are considered visible.

Blue light—comprises electromagnetic radiation having a wavelength in the approximate range of 400-480 nanometers.

Fluorescent Indicating Materials—includes fluorescent particles used in fluorescent magnetic particle testing or fluorescent dyes used in liquid penetrant testing.

Intense Source of Light—indicates a light source that produces an intensity of at least 1,000 microwatts per centimeter squared on the surface to be inspected when the light is at a distance of 15 inches from that surface.

Operation

In the following detailed description of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

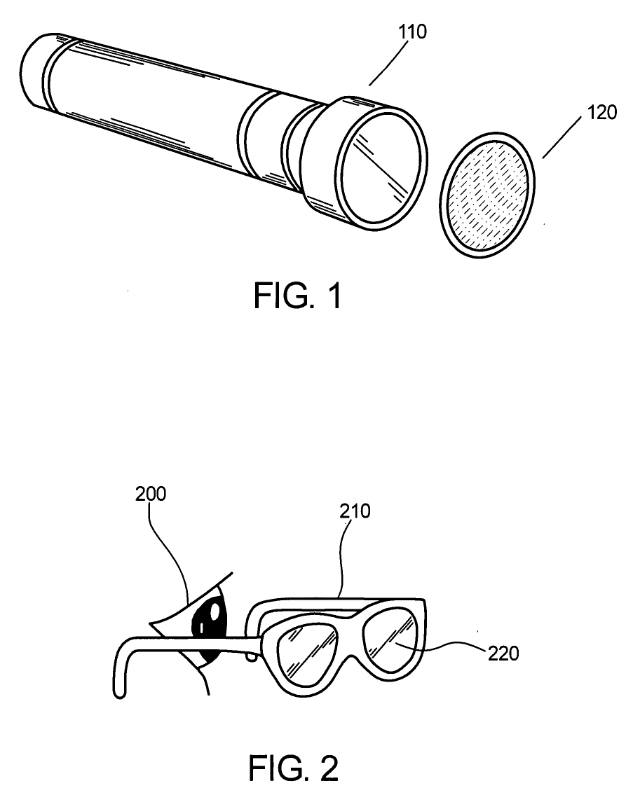

There are several alternative embodiments of the invention capable of being configured to meet different working methods. Referring to FIGS. 1 & 2, blue light is supplied by a hand-held flashlight type light source 110. Light source 110 derives power from batteries contained in the light body or from batteries or other electrical sources via a power cord. Light source 110 is optionally configured as an intense white light source such as a filament or discharge bulb fitted with excitation filter 120 that transmits only desired wavelengths for exciting fluorescence. Light source 110 is preferably one or more high intensity light-emitting diodes (LEDs) that emit a desired range of blue light wavelengths. The Luxeon and many similar LEDs emit light in a wide range of directions. In order to produce the needed intensity on the inspection surface it is desirable to add a focusing reflector or lens that channels the light into a small angle. An example is the model OP-005 spot optic from L2 Optics LTD, Manse Lane, Knaresborough, North Yorkshire, United Kingdom. LEDs supplemented by an excitation filter will further narrow the range of transmitted wavelengths. A visual inspector 200 views fluorescent indications through glasses 210 having lenses 220. Lenses 220 are yellow filters that block reflected excitation light yet transmit emitted fluorescence. Such yellow or other barrier filters can alternatively be embodied in a hand-held shield or similar device. Fluorescent indications can be seen best when there is little to no reflected excitation light reaching the observer. This is best achieved when the properties of the light source and the viewing filter are properly matched.

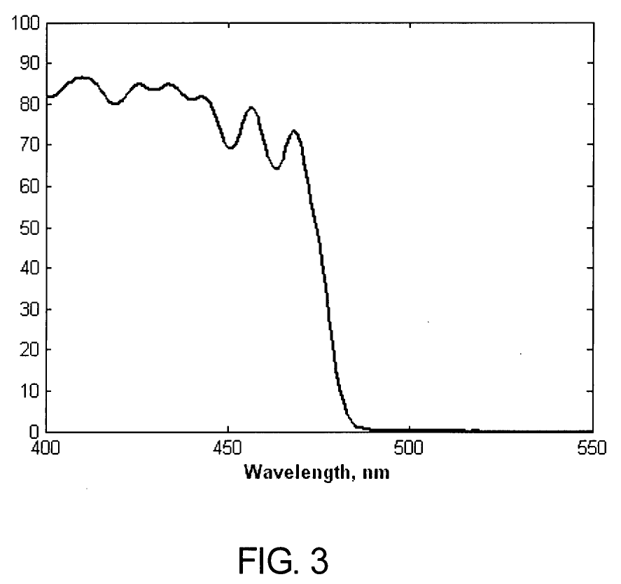

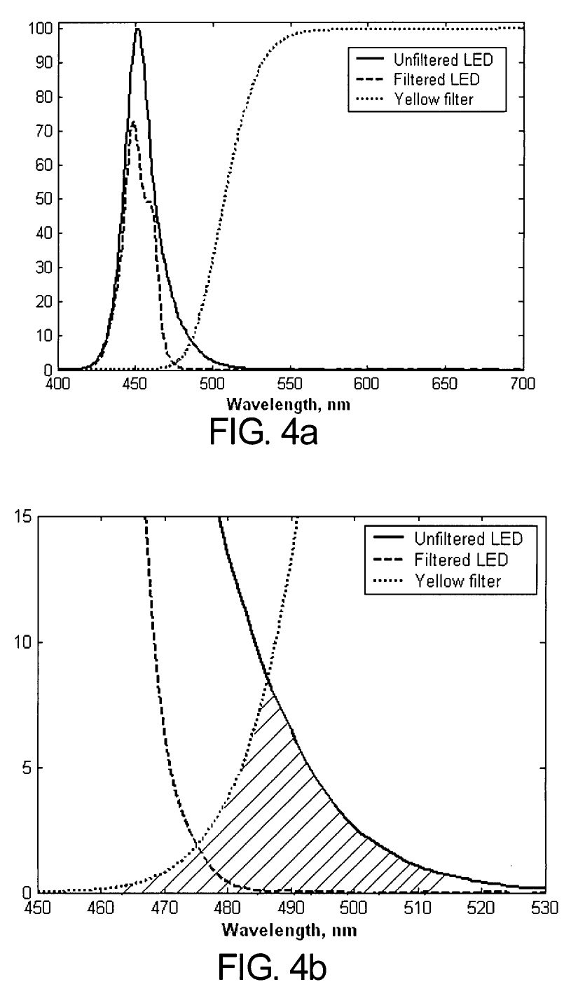

Referring to FIG. 3, the spectrum of the NightSea blue light excitation filter is shown. This filter passes a broad range of blue wavelengths and has a sharp cutoff in the vicinity of 470 nm. Referring to FIGS. 4a and 4b the impact of this filter is illustrated. The solid line in FIG. 4a shows the output spectrum of the Luxeon Royal Blue LED. The dotted line shows the transmission of a suitable yellow filter material, in this case the Model 430-7 acrylic from Cyro Industries, Parsippany, N.J. The dashed line shows the spectrum of the Luxeon LED after it has passed through the NightSea excitation filter of FIG. 3. FIG. 4b is an expanded view of the area of the graph where there is overlap between the emission of the LED and the transmission of the filter, indicated by the hash marks. The significance of the amount of overlap between the unfiltered LED and the transmission of the yellow filter is that it represents light from the source that could reflect from the surface being inspected and pass through the filter to the observer's eyes, reducing the contrast of the indication. The excitation filter reduces the overall intensity of the LED by a small amount, but the overlap between the light source and the viewing filter is reduced substantially, to a point where it is not significant for viewing.

In an alternative embodiment, a flashlight light source incorporates a second light source that provides unfiltered white light. The source of the unfiltered white light can be a filament or discharge-type bulb, or a white LED. Since a fluorescence inspection is almost always carried out in a darkened environment it is useful to have a source of white light readily available for making notes, picking up dropped objects, moving safely from one inspection location to another, and myriad other uses. In another embodiment, the white light source would supply illumination of sufficient intensity to meet the standards requirements for visible light (non-fluorescent) magnetic particle or liquid penetrant testing.

A flashlight light source provides a simple source of high intensity blue light, but a flashlight must be held by hand. Using one hand for holding a flashlight is not a significant problem for liquid penetrant testing, but for magnetic particle testing an inspector may use one hand to hold and energize an electromagnetic yoke and the other hand to apply and remove fluorescent indicating materials. This means that either an assistant is necessary, or that productivity of a single inspector dramatically decreases.

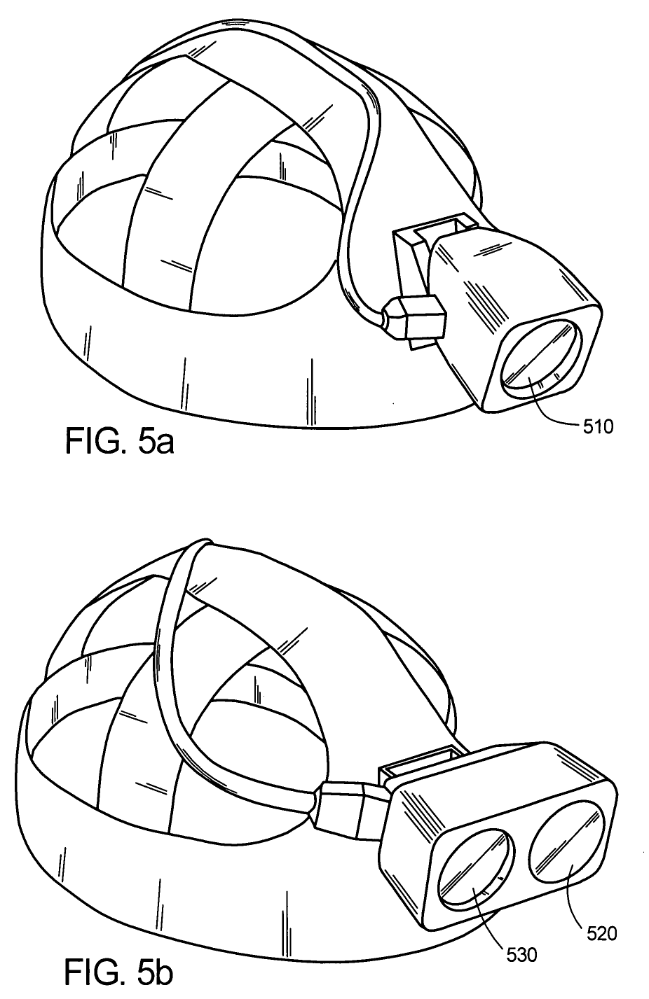

Referring to FIGS. 5a & 5b, in an alternative embodiment, a head-mounted lamp 510 incorporates one or more high intensity blue LEDs so that illumination can be directed at the work surface simply by the inspector moving his head. As with the flashlight described previously the blue LED is supplied with a collimating lens or reflector and is optionally supplemented with an excitation filter to further narrow the range of transmitted wavelengths. As with the flashlight, inspector 200 views fluorescent indications through glasses fitted with fluorescence barrier filters for lenses.

In addition to high intensity fluorescence excitation from one or more blue LEDs 520, in an alternative embodiment the headlamp incorporates one or more white-light LEDs 530 or a filament bulb. An added white light provides a convenient source of general illumination, useful in darkened inspection environments. Also, such a white light source illuminates sufficiently to meet light intensity standards requirements for visible light (non-fluorescent) magnetic particle or liquid penetrant testing.

In yet another embodiment, one or more blue LEDs, with optional supplementary filters, are incorporated in a module that surrounds one leg of an electromagnetic yoke used in magnetic particle testing. Such a module provides a path to energize a light source through induction, drawing energy from the yoke when energized. Such a module incorporating a source of white light was developed by and sold by Parker Research Corporation, 2642 Enterprise Road West, Clearwater Fla. 33763. Using such a module is described here as an alternative method of providing intense blue light to a work surface. Supplying excitation illumination through this module is completely hands-free and does not require its own source of power. This embodiment is not necessary for fluorescent liquid penetrant testing, which does not use an electromagnetic yoke.

In yet another embodiment, sources of blue and white light are mounted in a substantially stationary light source such as a desk lamp or a permanent lighting installation such as might be found at a dedicated inspection work station or in a dedicated work area.

The nondestructive testing industry has evolved standardized procedures over many years for fluorescent magnetic particle and fluorescent liquid penetrant testing. These standards help to ensure uniformity in testing methods and reliability of results. Ultraviolet lights and the fluorescent indicators developed by various manufacturers have co-evolved to provide fluorescent indications that are clear and bright enough to be reliably detected when tests are performed according to the prescribed procedures. With the present invention, replacing ultraviolet light with a blue-lightlyellow-filter combination to excite and view fluorescence provides indications at least equivalent to those provided by current ultraviolet light methods of nondestructive testing.

Brightness of a fluorescent indication is determined by fluorescent properties of a fluorescing material, and interaction with a light source. Fluorescence is a phenomenon in which light of a first wavelength is absorbed by a molecule and light of a second, longer wavelength is subsequently emitted by the molecule. Fluorescence occurs when a photon of light (“exciting light”) of a first wavelength is absorbed by an electron in a molecule, resulting in the electron reaching an “excited state.” Such an electron in an excited state is unstable and after a very brief interval the electron returns to its ground, or unexcited, state. The electron returning to a ground state may result in emitting a photon of light at a longer wavelength than that of the exciting photon. A molecule that exhibits fluorescence is referred to as a “fluorophor.” Any given fluorophor will be excited to fluoresce more efficiently by some wavelengths of light than other wavelengths of light. The relationship between wavelength of light and efficiency of excitation of a given fluorophor at a particular wavelength is described by the excitation spectrum of the given fluorophor. The excitation spectrum is essentially a graph of the relative ability of each wavelength of light to stimulate fluorescence. The excitation spectrum can also be considered a graph of the relative probability that a photon of a given wavelength will be absorbed, since photon absorption is the precursor to photon emission.

Commercial fluorophors prepared for fluorescent magnetic particle testing and fluorescent liquid penetrant testing are designed by manufacturers to provide adequate fluorescent brightness when illuminated with an ultraviolet light. Excitation spectra of such fluorophors can be examined to determine if each would also provide adequate fluorescent brightness when illuminated with blue light.

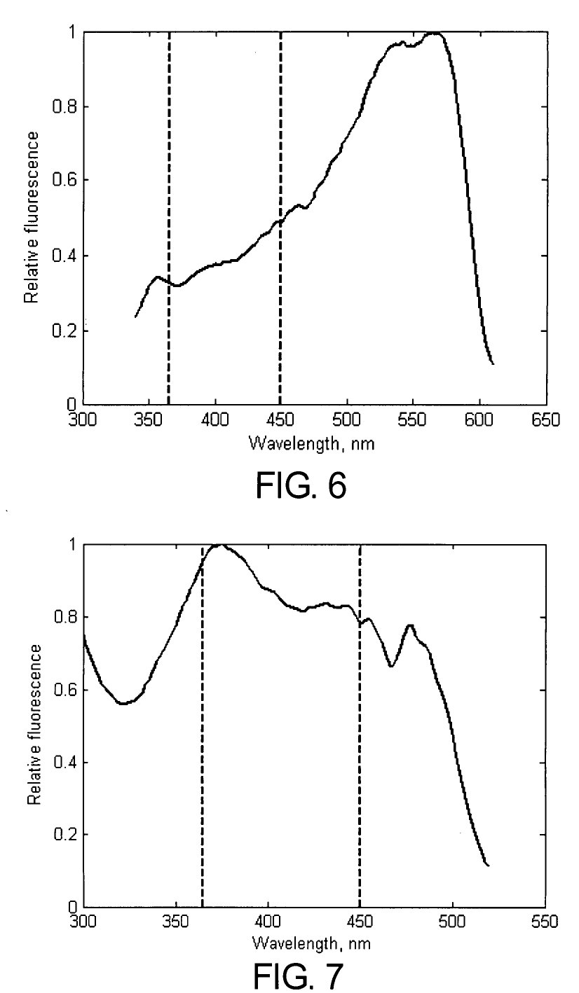

FIG. 6 shows the excitation spectrum for Sir-Chem® Dusting Powder 73 (manufactured by Circle Systems), a magnetic powder that emits a red fluorescence and is certified for use with ultraviolet light for fluorescent magnetic particle testing using a dry powder method. This excitation spectrum was measured with a FluoroMax-2 spectrofluorometer manufactured by Horiba Jobin-Yvon Spex Division, 3880 Park Avenue, Edison, N.J. 08820 USA, and the data were normalized to a maximum value of 100. Reading the graph at any wavelength directly provides the relative percent efficiency of any wavelength compared to a maximum. Intense ultraviolet lights used for inspection are almost all based on high pressure mercury vapor bulbs with a strong atomic emission line at 365 nanometers, thus this wavelength is used as a proxy for those lights. Similarly, 450 nm light, in the mid-blue range and at the maximum of some high intensity LEDs, is selected as a proxy for blue light excitation. These two values are indicated by vertical lines in FIG. 6. Relative excitation values are 32.5% for 365 nm and 48.8% for 450 nm, compared to the maximum of 100% at 564 nm. Comparing relative fluorescence at 450 nm to 365 nm shows that this wavelength of blue light is approximately 1.5 times more effective (48.8 divided by 32.5) than ultraviolet light at stimulating fluorescence.

FIG. 7 shows the excitation spectrum for Sir-Chem® Dusting Powder 75 (manufactured by Circle Systems), a magnetic powder that emits a green fluorescence. Like in FIG. 6, 365 nanometer and 450 nanometer wavelengths are indicated by dotted vertical lines. The excitation spectrum for this indicator is peaked in the ultraviolet range with a maximum at 374 nanometers. The relative excitation values are 95.4% at 365 nm and 78.0% at 450 nm. Thus blue light is only 0.82 (0.78/0.954) times as effective as ultraviolet at stimulating fluorescence with this particular dusting powder. The deficiency in excitation efficiency for the blue light can be made up for by using a blue light source that produces a greater intensity on the surface to be inspected. Since the specifications state that an ultraviolet source of 1,000 microwatts per centimeter squared can be used with these particles, a blue light source that produces approximately 1,200 microwatts per centimeter squared can be used to produce the same fluorescence intensity in the indicating particles. Blue lights that we have made with the Luxeon Royal Blue LED with the NightSea interference filter produced an illumination intensity in the range of 1,500 to 1,800 microwatts per centimeter squared at a working distance of 15 inches.

From a technical point of view it is reasonable to replace ultraviolet light with blue light for inspection using the two fluorescent indicators described above. A similar comparison performed for each of the wet or dry fluorescent materials currently used for fluorescent magnetic particle or fluorescent liquid penetrant testing is beneficial to certify that a particular fluorescent indicator is suitable for use in the method of the present invention.

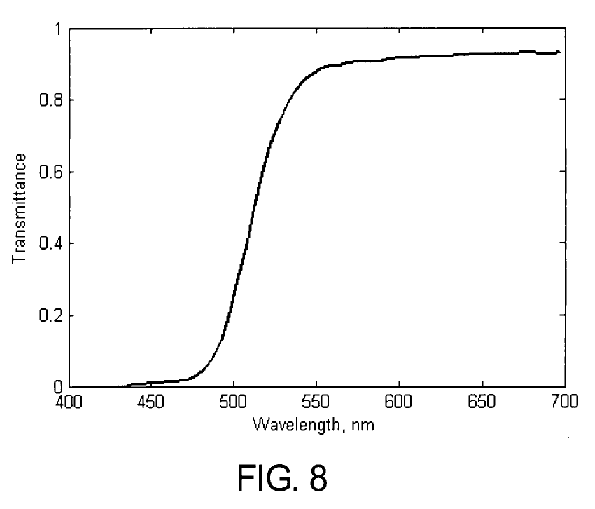

A consideration in this comparison is that fluorescence induced by blue light must be viewed through a yellow filter that removes reflected blue light and passes only stimulated fluorescence. A filter material such as the Tiffen #12 or Kodak Wratten #12 filter or the CYRO Industries 430-7 acrylic is suitable for this purpose. The percent transmittance as a function of wavelength for the 430-7 filter is shown in FIG. 8. Light transmittance of the filter at wavelengths longer than 550 nm is greater than 90%, but it is necessary to reduce the effectiveness of this method to account for any transmittance less than 100%. ASTM standards documents and the manufacturers' recommendations, however, require that an inspector view ultraviolet-induced fluorescence indications through ultraviolet-blocking safety glasses to protect eyes. Typical glasses used in the field do not have anti-reflection coatings, and their maximum transmittance is about 92% due to reflections at the front and back surface of the lenses. Because the effectiveness of both methods needs to be adjusted by a similar factor, the transmittance of the yellow filter described here has no significant effect.

In another embodiment of the invention provision is made for pulsing (flashing) the blue LED at a frequency in the vicinity of 10 Hz to enhance the utility of the fluorescence inspection process when there is ambient light that exceeds the 2 footcandle level called for in nondestructive testing. In one version there are two LEDs contained in the light and the light includes a means of selecting one LED or the other. One of the LEDs is controlled by a circuit that causes it to emit light continuously, while the other is controlled by a circuit that causes it to pulse at the desired frequency. In another version there is one LED and the switch selects between two different driving circuits for that LED.

Magnetic particle testing is sometimes used for inspection of underwater structures. The only commercially available underwater ultraviolet lights made for diver use for magnetic particle inspections are two models (Blackbirn) produced by Birns Inc., 1720 Fiske Place, Oxnard, Calif. 93033. The lights are bulky and expensive. Their size makes them impractical for mounting to a commercial diver's helmet, requiring that they be hand held. The blue light system can be implemented in a much smaller package that can be attached to a diver's helmet. The yellow barrier filter material can be installed in existing welding glass fixtures that are commercially available for diver helmets. In addition to the size issue, blue light has an advantage over ultraviolet in that it experiences less absorption by dissolved organic matter in the water column. Thus for equal initial intensities of ultraviolet and blue light emitted from a light source, the percentage of that initial intensity that reaches the inspection surface would be greater for the blue than the ultraviolet light. The exact difference would depend on the specific optical properties of the water in which the inspection is being performed.

In another embodiment of the invention, added video synchronization for the light source enables video capture. For example, a LED light source pulses or blinks every third frame to reproduce the blinking effect on video. The blinking light effect increases detectability of indications in the presence of ambient light. This effect can be reproduced if a video camera is used for viewing indications by synchronizing the illumination of the light source with the image collection of the video camera. A conventional video camera collects images at the rate of thirty frames per second. If it is arranged that the LED illumination is energized in synchronization with every third frame of the video then the LED will be blinking ten times per second so that the blinking effect will be evident on the video image. This synchronization can be achieved through use of an appropriate electronic circuit. As an example, the LM1881 integrated circuit from National Semiconductor, 2900 Semiconductor Dr., Santa Clara, Calif., 95052, accepts the composite video signal from a video camera as input and outputs several signals derived from the video input, including a signal that alternates between high and low voltage levels in synchronization with the odd and even fields of the video image. Each video frame is comprised of one odd and one even field. This odd/even field output is input into a ripple counter integrated circuit such as the CD4017, available from a number of manufacturers. Each high/low cycle of the video field signal output from the LM1881 causes a high voltage to move from one output pin of the CD4017 to another. Connecting the fourth output pin of the CD4017 to the RESET pin of the CD4017 causes that counter to begin its count again, with the result that a high voltage level will appear on the first three output pins in turn at a rate of ten times per second for each of those pins. An integrated circuit such as the LM2941 voltage regulator from National Semiconductor can be configured to provide the correct drive current to the LED source and also has an input pin that enables on/off control of the voltage regulator output from an external signal. The voltage output from any one of the three output pins on the CD4017 device could then be input to the LM2941 control pin to turn the LED light source on only during the time that the voltage is at its high level, thus achieving synchronization with every third frame of the video. Other circuits and components that achieve the same effect are possible, and synchronization can also be achieved with European video formats, which have a slightly different frame rate, through the same approach.

An optional remote control switches the light source from steady illumination to pulsed illumination. The light source can be constructed for underwater use, with or

1. A method of nondestructive testing comprising:
providing a source of blue light;
matching a barrier filter with the source of blue light so that the barrier filter blocks substantially all blue light emitted by the source of blue light;
selecting a fluorescent indicating material designed to be excited using ultraviolet light, wherein said fluorescent indicating material also fluoresces using the source of blue light;
applying the fluorescent indicating material to a test surface;
illuminating the test surface with the source of blue light thereby causing the fluorescent indicating material to fluoresce;
filtering reflected blue light from the test surface using the barrier filter; and
detecting faults on the test surface from fluorescing indications.

2. The method of claim 1, wherein the source of blue light is one or more light-emitting diodes.

3. The method of claim 1, wherein the source of blue light is light-emitting diodes, and wherein excitation filters are used to limit spectral output of the light-emitting diodes.

4. The method of claim 1, wherein the source of blue light is supplied by an intense broadband light and an excitation filter.

5. The method of claim 1, further comprising pulsing the source of blue light.

6. The method of claim 1, further comprising pulsing the source of blue light and synchronizing image collection on a video camera with pulsed blue light.

7. The method of claim 1, wherein the source of blue light is adapted for underwater use. without blinking. The light source is optionally configured to receive power from multiple light sources such as non-rechargeable batteries, rechargeable batteries, a belt power pack with higher-capacity batteries, or a wall-plugged DC power supply.
It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

8. A method for illuminating and viewing fluorescent indicating materials used in fluorescent magnetic particle and fluorescent liquid penetrant testing comprising:
providing an intense source of blue light;
providing a barrier filter that blocks blue light from said source of blue light;
selecting a fluorescent indicating material designed to be excited using ultraviolet light;
applying the fluorescent indicating materials to a body;
exciting the fluorescent indicating materials on the body using the source of blue light;
filtering reflected blue light using the barrier filter; and
observing faults on the body in the forms of fluorescing indications.

9. The method of claim 8, wherein the source of blue light is one or more light-emitting diodes.

10. The method of claim 8, wherein the source of blue light is light-emitting diodes, and wherein excitation filters are used to limit spectral output of the light-emitting diodes.

11. The method of claim 8, wherein the source of blue light is provided in a module adapted to attach to an electromagnetic yoke and receive power through induction from an energized electromagnetic yoke.

12. The method of claim 8, wherein the source of blue light is contained in a hand-held portable housing.

13. The method of claim 8, wherein the source of blue light is contained in a head-mounted lamp.

14. The method of claim 8, further comprising a source of white light for general area illumination.

15. The method of claim 8, wherein the source of blue light is adapted for receiving power from multiple sources.

16. The method of claim 8, further comprising a source of white light of sufficient intensity to meet standards requirements for white-light illumination for visible light magnetic particle or liquid penetrant testing.

17. A method of nondestructive testing comprising:
selecting a commercially available fluorescent indicating material manufactured to be excited using ultraviolet light, wherein said fluorescent indicating material also fluoresces using blue light;
selecting a source of blue light that causes the fluorescent indicating material to fluoresce, wherein the source of blue light is one or more light-emitting diodes;
providing a portable housing for said source of blue light;
matching a yellow barrier filter with the source of blue light so that the yellow barrier filter blocks substantially all blue light emitted by the source of blue light;
applying fluorescent indicating materials to a test region of a surface;
directing the source of blue light to the test region of the surface thereby causing the fluorescent indicating materials to fluoresce;
filtering reflected blue light from the region using the yellow barrier filter, thereby enabling fluorescent indications to be seen with high contrast; and
detecting faults on the test surface from fluorescing indications.

18. The method of claim 17, wherein excitation filters are used to limit spectral output of the light-emitting diodes.

19. The method of claim 17, wherein the source of blue light is provided in a module adapted to attach to an electromagnetic yoke and receive power through induction from an energized electromagnetic yoke.

20. The method of claim 17, further comprising pulsing the source of blue light and synchronizing image collection on a video camera with pulsed blue light.
